(19) United States
(12) Patent Application Publication
(10) Pub. No.: US 2015/0221229 A1
(43) Pub. Date: Aug. 6, 2015

(54) ASYNCHRONOUS ONLINE LEARNING

(71) Applicant: Colorado State University Research Foundation, Fort Collins, CO (US)

(72) Inventors: Joseph P. Cannon, Fort Collins, CO (US); Brian Fugate, Fort Collins, CO (US)

(21) Appl. No.: 14/611,072

(22) Filed: Jan. 30, 2015

Related U.S. Application Data
(60) Provisional application No. 61/934,100, filed on Jan. 31, 2014.

(51) Int. Cl. G09B 7/04

(52) U.S. Cl. CPC G09B 7/04

(57) ABSTRACT

A method includes presenting to an online learner a first question. The method also includes receiving a first answer of the online learner to the first question. The method also includes presenting to the online learner a second question that requests a justification for the first answer. The method also includes receiving a second answer of the online learner to the second question. The method also includes storing, in a learner account of the online learner, the second answer in association with the first answer. The method also includes finding a different second answer of a different online learner and which is associated with a different first answer of the different online learner. The method also includes presenting the different second answer to the online learner.

### CROSS-REFERENCE TO RELATED APPLICATIONS

This application is a non-provisional of, and claims the benefit of, U.S. Provisional Patent Application Ser. No. 61/934,100, entitled “Method for Asynchronous Online Learning,” filed Jan. 31, 2014, the entirety of which is incorporated herein by reference for all purposes.

### BACKGROUND

Unless otherwise indicated herein, the materials described herein are not prior art to the claims in the present application and are not admitted to be prior art by inclusion in this section.

E-learning is an inclusive term that describes educational technology that electronically or technologically supports learning and teaching. E-learning includes numerous types of media that deliver content such as text, audio, images, animation and video through technology applications and processes such as computers, local intranet/extranet and the Internet. E-learning can occur in or out of the classroom and is sometimes referred to as online learning. It can be self-paced, asynchronous learning or may be instructor-led, synchronous learning. E-learning/online learning is suited to distance learning and flexible learning, but it can also be used in conjunction with face-to-face teaching, in which case the term blended learning is commonly used.

The subject matter claimed herein is not limited to embodiments that solve any disadvantages or that operate only in environments such as those described above. Rather, this background is only provided to illustrate one example technology area where some embodiments described herein may be practiced.

### SUMMARY

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

Embodiments described herein generally relate to providing active learning in asynchronous online learning settings.

An aspect of online learning that may be attractive to many students is its flexibility in terms of time and/or location. For instance, some online learning courses permit students to learn some or all material associated with the online learning course asynchronously. In addition, such online learning courses may also permit students to learn some or all material associated with the online learning course from home or other decentralized location. In particular, such online learning courses may permit students to access available learning materials over a network such as the Internet using a personal computer at any time. This flexibility may allow students to work steady jobs and fulfill other responsibilities while fitting in at least some of the online learning course at their convenience and without having to commute to a centralized location to meet with an instructor and other students enrolled in the online learning course.

### Technical Problem

The asynchronous nature of some online learning courses may create a problem absent from traditional synchronous and centralized (e.g., classroom) learning. In this regard, many of the most effective college classrooms and other traditional synchronous and centralized learning settings utilize active learning pedagogies in which students interact with each other and the instructor to foster cognitive engagement, higher-level learning, and critical thinking One problem with existing asynchronous computer-assisted online learning platforms is their inability to implement such active learning pedagogies to achieve higher learning objectives related to critical thinking since the students access the learning materials asynchronously and therefore generally do not interact with each other or the instructor during learning.

### Technical Solution

Embodiments described herein overcome the foregoing technical problem unique to asynchronous computer-assisted online learning through, e.g., a computer application that provides active learning exercises in asynchronous online settings for online students. In particular, the computer application promotes and develops higher order cognition and critical thinking with one or more of the following features: a) activities that iterate between consuming content and reacting to new content and the perspectives of other students, b) the flexibility to utilize a wide range of pre-existing and instructor developed content, c) student-instructor and student-student interaction, d) instructor monitoring and reacting to student activity, and e) simple opportunities to evaluate and coach individual students. Unlike existing asynchronous computer-assisted online learning platforms, embodiments described herein allow student interaction (see features a-d above) to be completed in one sitting, e.g., of about 10 minutes to an hour in some cases, yet students are not required to participate synchronously. Nor do the students have to engage in a back and forth of communications with other students or the instructor, which may require the user to return to their computer multiple times or remains at their computer while waiting for communications from other students or the instructor as mentioned, student interaction can be completed in one setting.

Accordingly, in an example embodiment, a method to provide active learning in an asynchronous online setting includes presenting content to online learners (e.g., students) that may access the content asynchronously. The content can include text, audio, video, or any other content, and may be selected by an instructor from existing content or may be generated by the instructor. Online learners may be asked a closed-ended question related to the content and that has at least two possible discrete answers. The closed-ended question and the discrete answers may be provided by the instructor. The online learners may also be asked to justify their response to the closed ended question and each online learner's justification may be stored in association with the response to the closed-ended question. The closed-ended question and the request for justification may force the student to take and defend a position.

For each online learner, the computer application may identify one or more peer responses (e.g., justifications) from other students that are associated with responses to the closed-ended question that agree (e.g., are the same as) and/or disagree (e.g., are different than) with the online learner's response to the closed-ended question and associated justification or otherwise offer a different perspective than the online learner's response to the closed-ended question and associated justification. The computer application may present the identified peer responses from other online learners to the online learner. The instructor may specify a number of peer responses from other online learners to present to the online learner, including a first number (e.g., 0, 1, 2, 3, . . . ) of peer responses that agree and a second number (e.g., 0, 1, 2, 3, . . . ) of peer responses that disagree with the online learner's response.

The online learner may be asked to read and evaluate the peer responses. The evaluation process may force the online learner to engage in higher-order learning processes. In some instances, after presenting the peer responses to the online learner, the closed-ended question may be presented to the online learner again to reconsider his/her prior response to the closed-ended question, e.g., in view of the peer responses. Alternatively or additionally, the online learner may be asked to otherwise react to the peer responses. For example, the online learner may be asked to defend their position in the face of peer responses that disagree with the online learner. This causes the online learner to achieve higher-order learning objectives, including forcing the online learner to engage with learning material (e.g., presented content, questions, and peer responses) and justify the online learner's position.

The process of asking the online learner a closed-ended question, requesting justification, presenting peer responses, and requesting a reaction to the peer responses may be repeated multiple times within a single exercise as desired by the instructor. Each arrangement or group of closed-ended question, request for justification, peer responses, and request for reaction within an exercise that includes multiple such arrangements or groups may be referred to as a learning iteration.

It is not necessary that each embodiment include all aspects and features summarized above and/or other aspects and features described herein. For instance, in an example embodiment, a method includes presenting to an online learner a first question with at least two possible discrete answers. The method also includes receiving a first answer of the online learner to the first question. The method also includes presenting to the online learner a second question that requests a justification for the first answer. The method also includes receiving a second answer of the online learner to the second question. The method also includes storing, in a learner account of the online learner, the second answer in association with the first answer. The method also includes finding a different second answer of a different online learner and which is associated with a different first answer of the different online learner, where the different first answer and the different second answer disagree with the first answer and the second answer of the online learner or present a different perspective than the first answer and the second answer. The method also includes presenting the different second answer to the online learner.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a block diagram of an example operating environment in which some embodiments may be implemented;

FIG. 2 is a block diagram illustrating an example device to provide active learning in asynchronous online settings;

FIG. 3A is a graphic of an example interface to create and/or edit an exercise;

FIGS. 3B-3E are graphics of example interfaces to administer exercises to learners;

FIG. 3F is a graphic of an example interface to facilitate instructor assessment of exercises completed by learners;

FIG. 3G is a graphic of another example interface to facilitate instructor assessment of exercises completed by learners;

FIG. 3H is a graphic of an example interface to provide feedback to a learner for each exercise completed by the learner;

FIGS. 4A-4E are graphics of specific example implementations of some of the interfaces of FIGS. 3A-3H; and

FIG. 5 shows an example flow diagram of a method to provide active learning in an asynchronous online setting.

### DETAILED DESCRIPTION

Reference will now be made to the drawings to describe various aspects of some example embodiments of the invention. The drawings are diagrammatic and schematic representations of such example embodiments, and are not limiting of the present invention, nor are they necessarily drawn to scale.

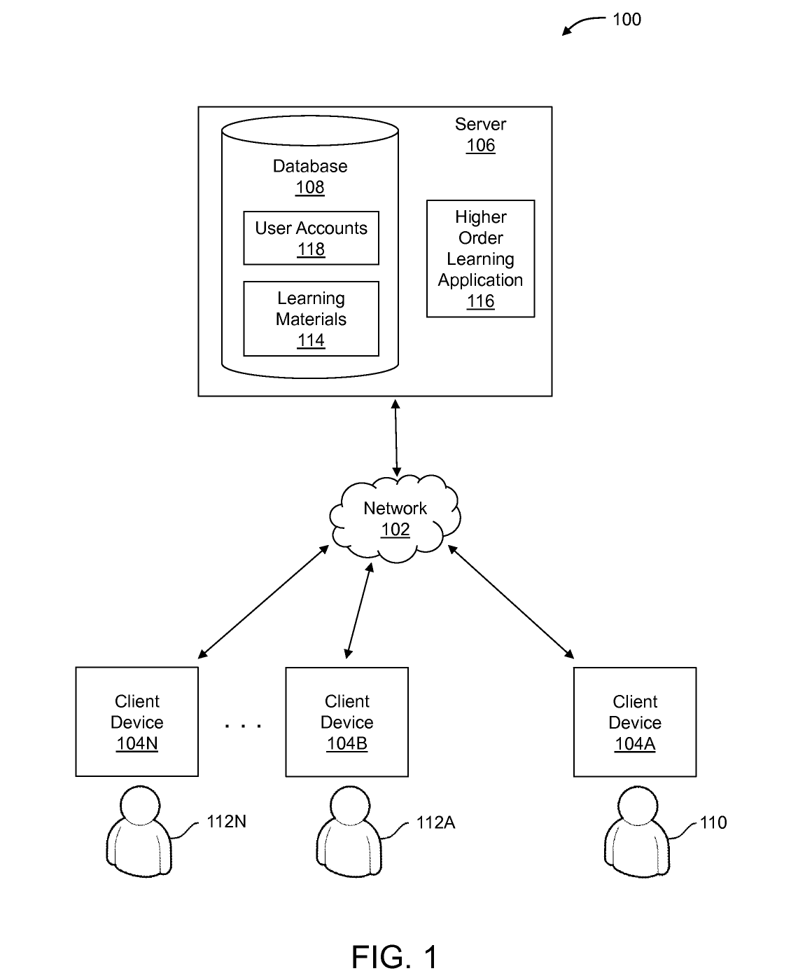

FIG. 1 is a block diagram of an example operating environment 100 in which some embodiments may be implemented. The operating environment 100 may include a network 102, one or more client devices 104A-104N (hereinafter “client device 104” or “client devices 104”), a server 106, a database 108, an instructor 110, and one or more online learners 112A-112N (hereinafter “learner 112” or “learners 112”).

In general, the network 102 may include one or more wide area networks (WANs) and/or local area networks (LANs) that enable the client devices 104, the server 106, and/or the database 108 to communicate with each other. In some implementations, the network 102 includes the Internet, including a global internetwork formed by logical and physical connections between multiple WANs and/or LANs. Alternately or additionally, the network 102 may include one or more cellular RF networks and/or one or more wired and/or wireless networks such as, but not limited to, 802.xx networks, Bluetooth access points, wireless access points, IP-based networks, or the like. The network 102 may also include servers that enable one type of network to interface with another type of network.

Each of the client devices 104 may be associated with a corresponding one of the learners 112 or the instructor 110. For example, each of the client devices 104A, 104B, 104N is respectively associated with the instructor 110, the learner 112A, and the learner 112N. In the description that follows, certain interactions of the server 106 or other devices with the instructor 110 and the learners 112 are described with the understanding that such interactions are completed with the aid of the client devices 104. For instance, the server 106 may present content, questions, or other material to the learners 112 and/or the instructor 110, which means that the server 106 may provide the content, questions, or other material to the corresponding client device 104, which client device 104 may then output the content, questions, or other material to the learners 112 or the instructor 110.

Each of the client devices 104 may include a desktop computer, a laptop computer, a tablet computer, a mobile phone, a smartphone, a personal digital assistant (PDA), an e-reader device, or other suitable client device capable of electronic communication through a network such as the network 102. The client devices 104 may each include a browser or other application configured to communicate with the server 106 to access learning materials 108 hosted by the server 106. Each client device 104 may additionally include an output device (e.g., display device, audio device, haptic device) to output, to the learners 112, learning materials 114 and/or other information accessed from the server 106. Each client device 104 may additionally include an input device (e.g., mouse, microphone, touchscreen, keyboard) through which the learners 112 or the instructor 110 may provide input.

The server 106 may host the database 108 (including the learning materials 114) and a higher order learning application 116 (hereinafter “application 116”). Alternatively, the database 108 may be accessible to the server 106, e.g., locally or remotely, without being hosted by the server 106. The server 106 may include a rack-mounted server computer, a blade server computer, and/or other computer hardware.

The database 108 may include user accounts 118 and the learning materials 114. The user accounts 118 may include an account for each user in the operating environment of FIG. 1. “Users” may include the learners 112 as well as the instructor 110. The learning materials 114 may generally include materials used to provide active learning in asynchronous online settings.

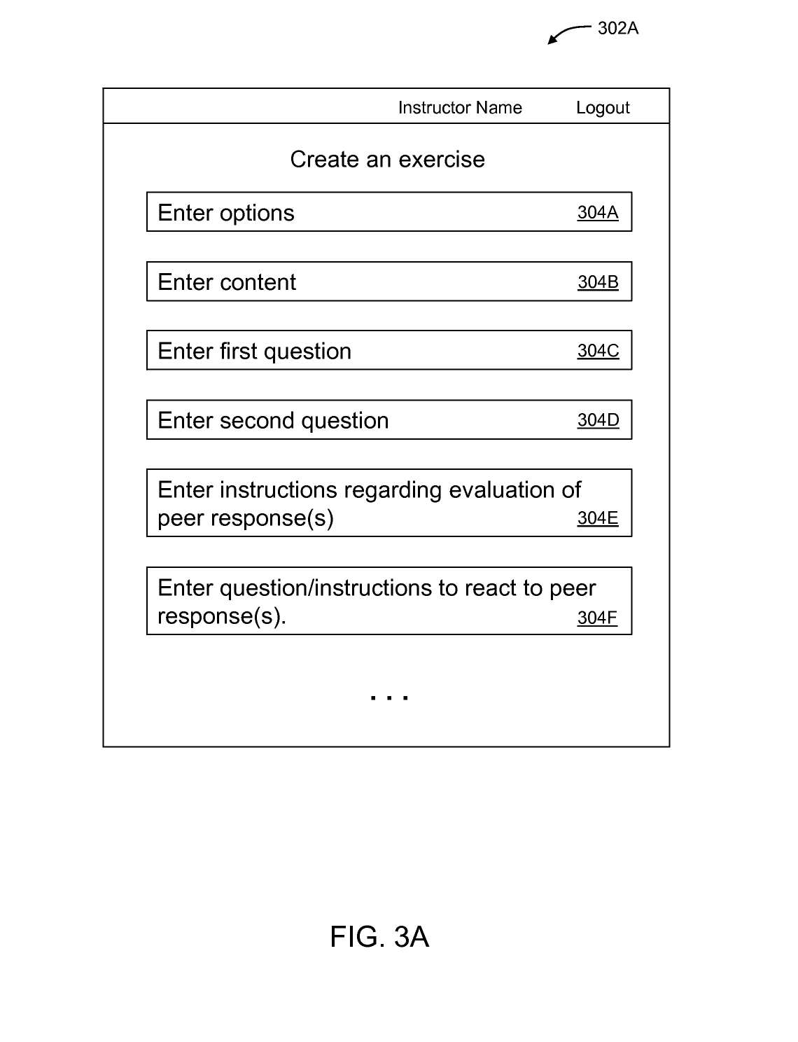

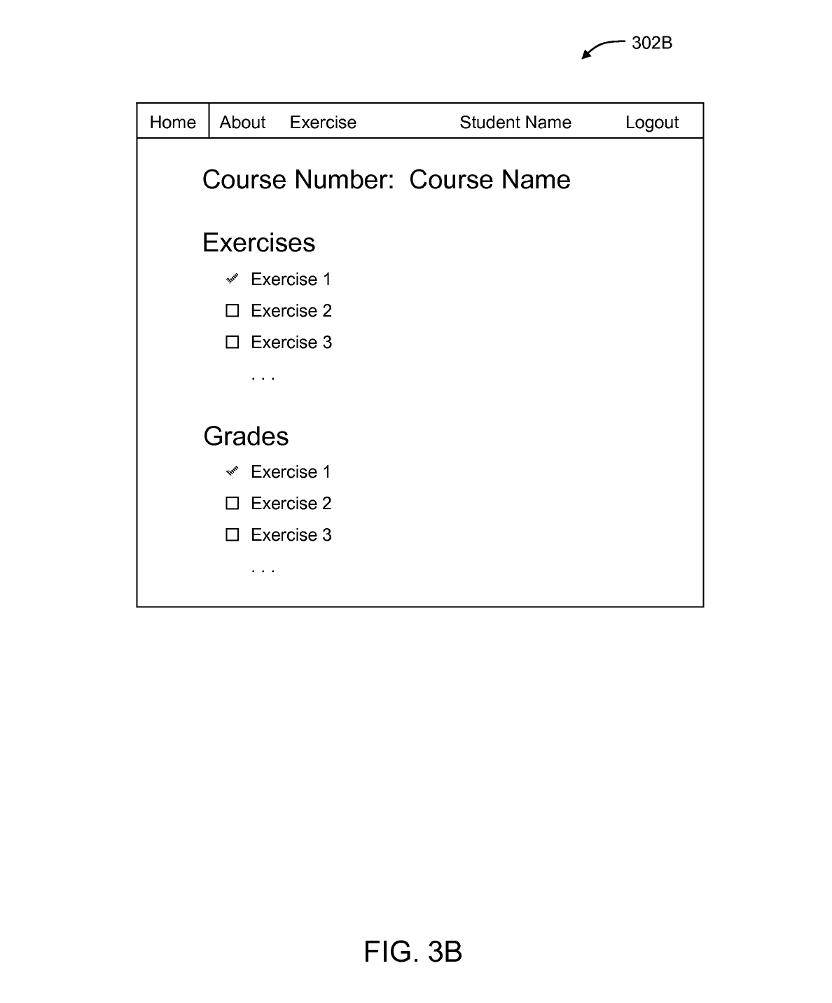

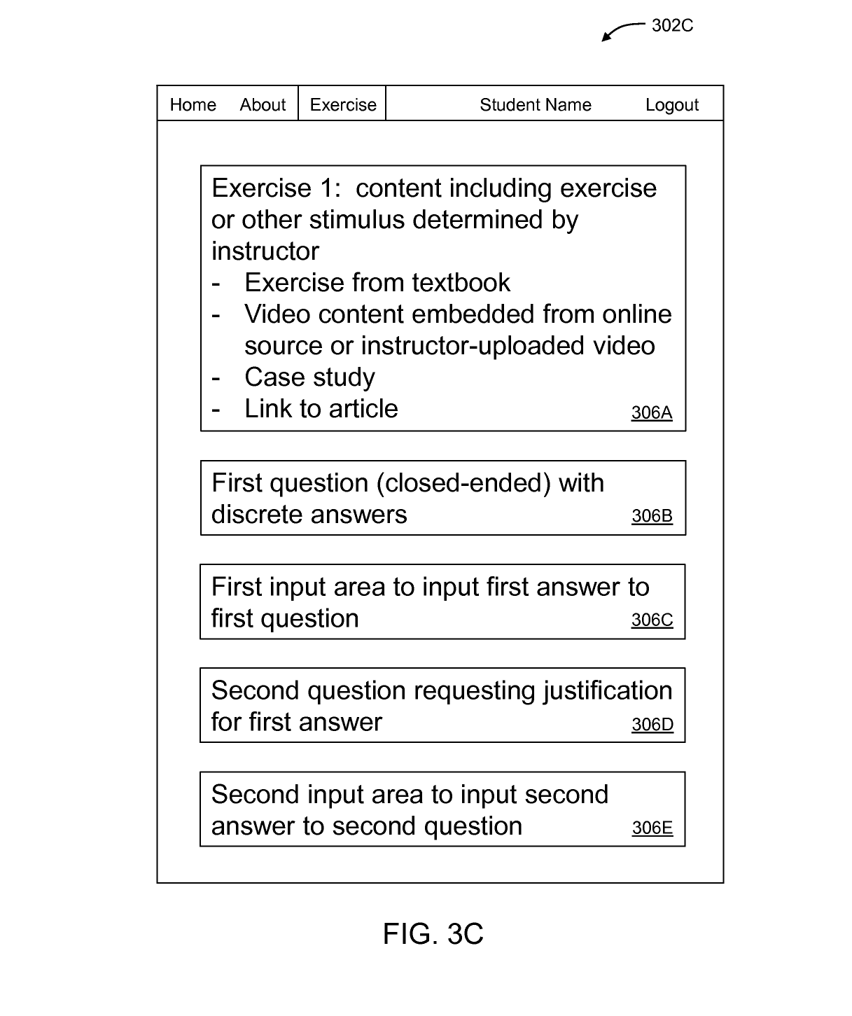

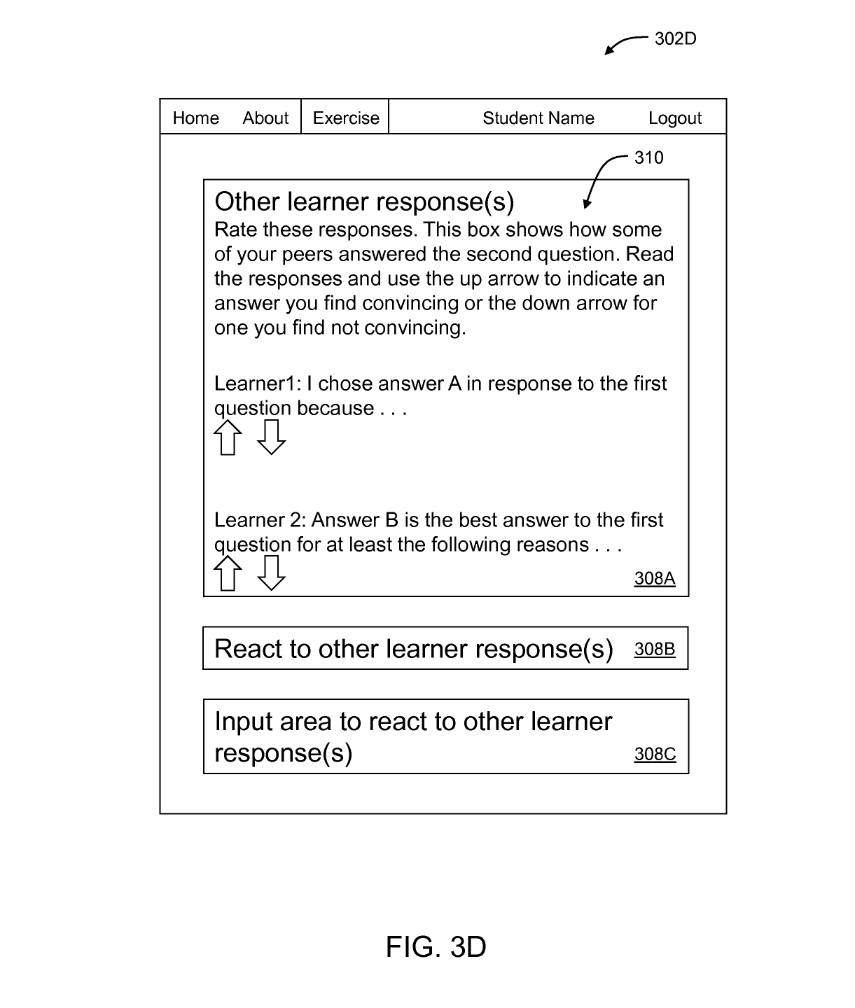

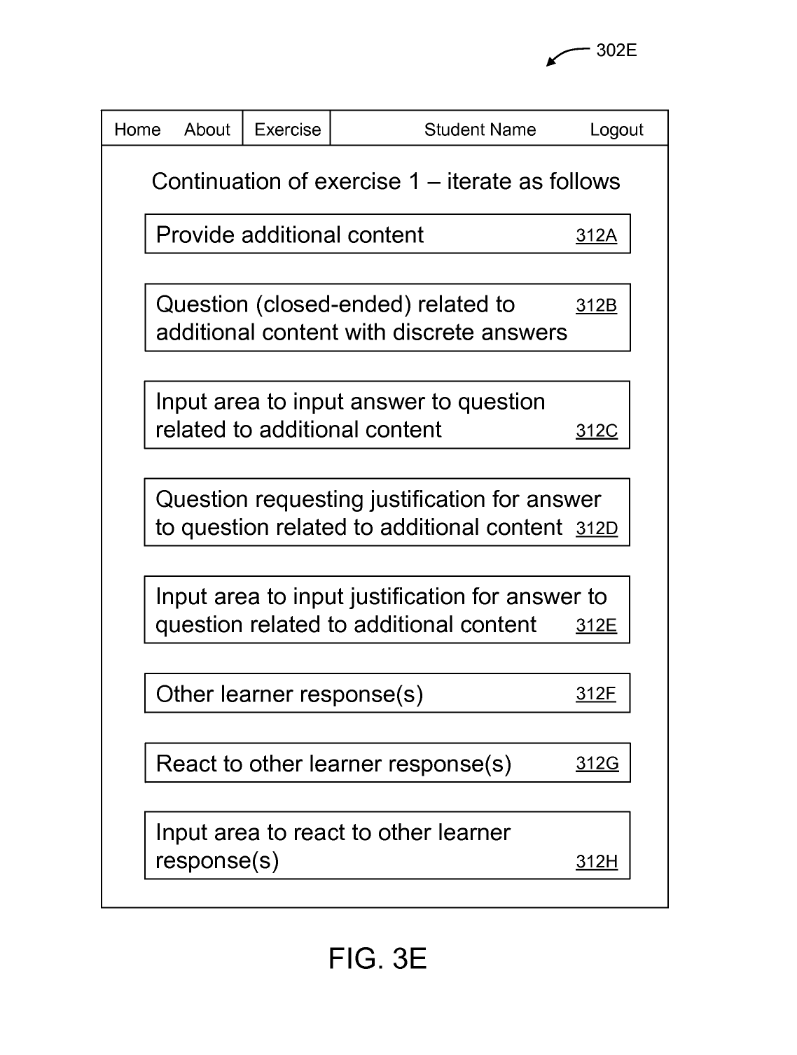

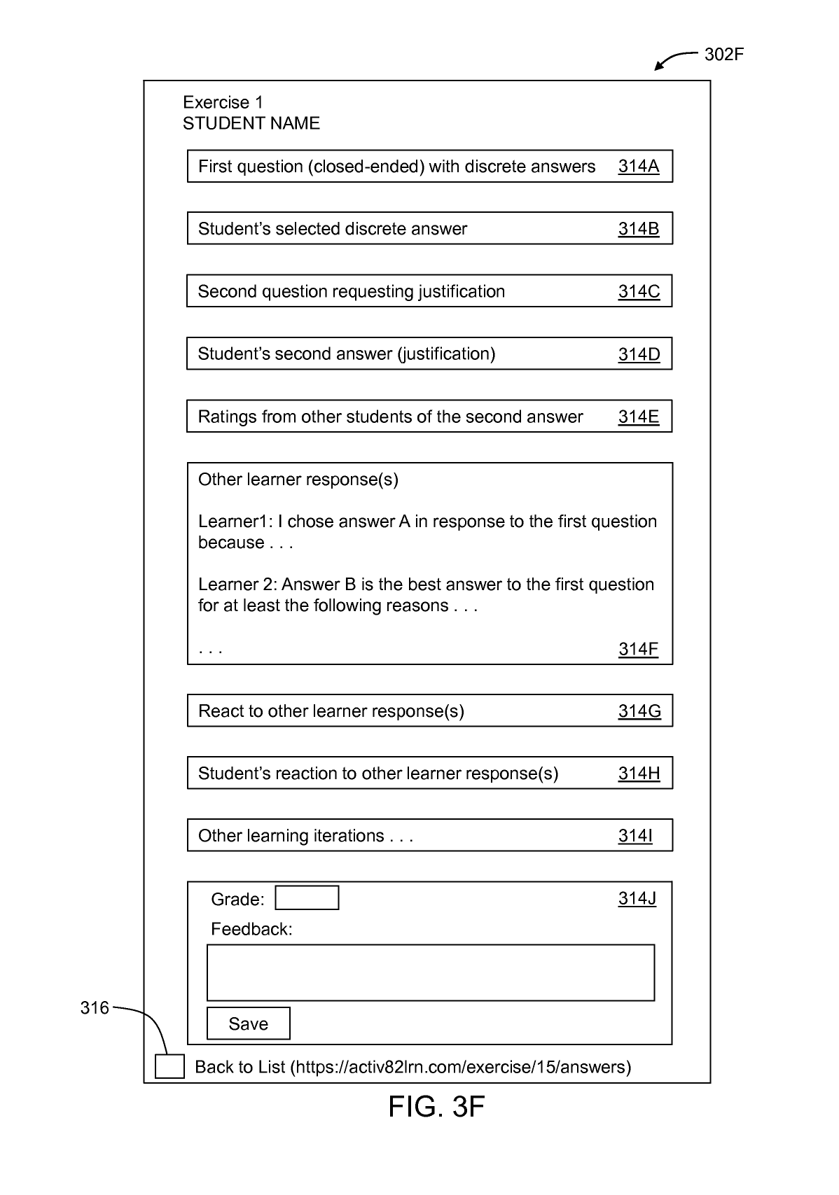

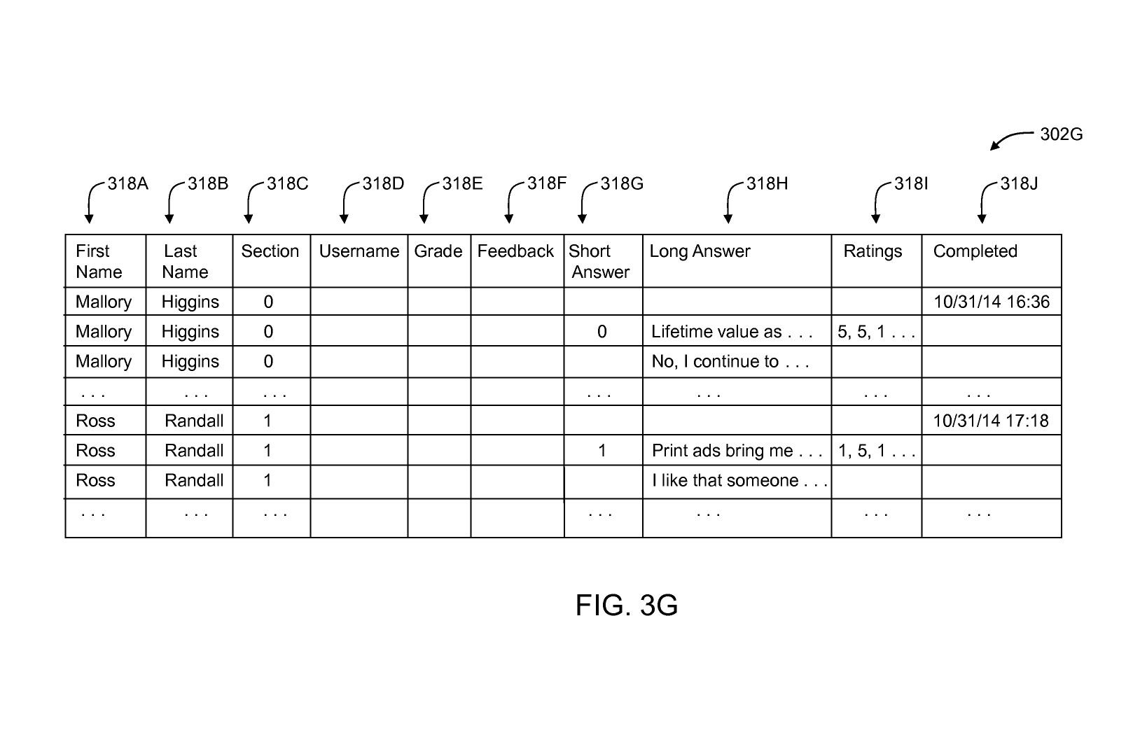

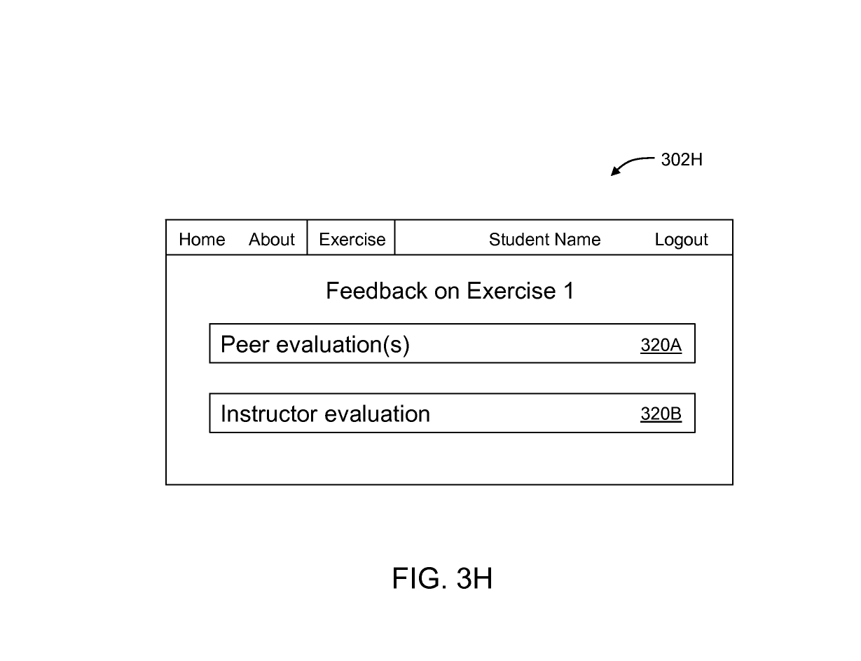

The application 116 may provide active learning in asynchronous online settings as generally described herein, including by performing one or more of the operations described in the context of FIGS. 3A-5 below.

The instructor 110 may include an instructor of one or more online courses. Although a single instructor 110 is illustrated in FIG. 1, the operating environment 100 may more generally include one or more instructors 110.

Each of the learners 112 may include an individual that participates in one or more online courses. Each of the learners 112 may include a student in the narrow sense of the word, e.g., a person who is formally enrolled in and studying at a school or college that offers online courses to its students. More generally, each of the learners 112 may include any individual that participates in one or more online courses, whether or not the individual is formally enrolled in and studying at a school or college. While multiple learners 112 are illustrated in FIG. 1, the operating environment 100 may more generally include one or more instructors 110.

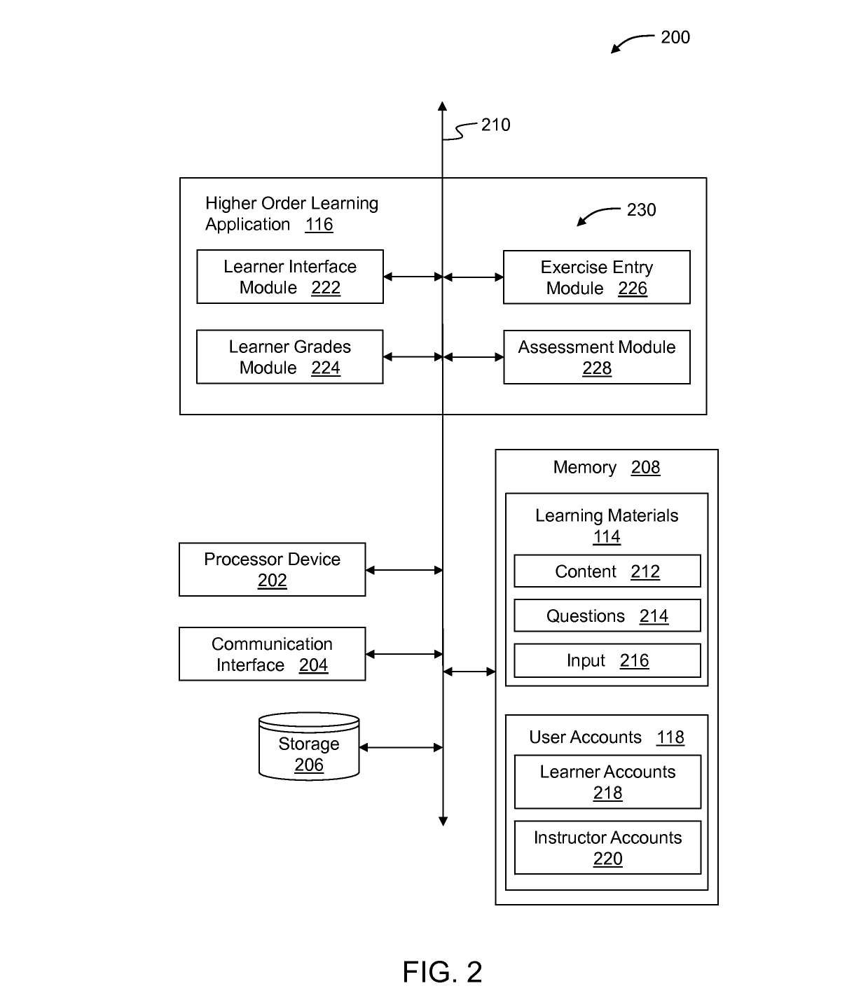

FIG. 2 is a block diagram illustrating an example device 200 to provide active learning in asynchronous online settings, arranged in accordance with at least one implementation described herein. The device 200 may include or correspond to the server 106 of FIG. 1. The device 200 may be implemented as a computing device having any suitable form factor, such as a rack-mounted server computer, a blade server computer, and/or other computer hardware.

The device 200 may include the application 116, a processor device 202, a communication interface 204, a storage 206, and a memory 208 according to some examples. The components of the device 200 may be communicatively coupled by a bus 210. The bus 210 may include, but is not limited to, a memory bus, a storage interface bus, a bus/interface controller, an interface bus, or the like or any combination thereof.

The processor device 202 includes an arithmetic logic unit, a microprocessor, a general-purpose controller, or some other processor or processor array to perform or control performance of operations as described herein. The processor device 202 processes data signals and may include various computing architectures including a complex instruction set computer (CISC) architecture, a reduced instruction set computer (RISC) architecture, or an architecture implementing a combination of instruction sets. Although FIG. 2 includes a single processor device 202, multiple processor devices may be included. Other processors, operating systems, and physical configurations may be possible.

The memory 208 stores instructions and/or data that may be executed and/or operated on by the processor device 202. The instructions or data may include programming code that may be executed by the processor device 202 to perform or control performance of the operations described herein. The memory 208 may include a dynamic random access memory (DRAM) device, a static random access memory (SRAM) device, flash memory, or some other memory device. In some implementations, the memory 208 also includes a non-volatile memory or similar permanent storage and media including a hard disk drive, a floppy disk drive, a CD-ROM device, a DVD-ROM device, a DVD-RAM device, a DVD-RW device, a flash memory device, or some other mass storage for storing information on a more permanent basis.

Alternatively or additionally, the instructions or data stored on the memory 208 may include the learning materials 114 and the user accounts 118. The learning materials 114 and/or the user accounts 118 may be organized and/or stored in the form of a database, such as the database 108 of FIG. 1.

The learning materials 114 may include content or links to such content, designated as “content 212” in FIG. 2, as well as questions 214 and/or input 216 from other users (e.g., from other learners 112 or the instructor 110). For example, the content 212 may include an exercise from a textbook, video content embedded from an online source, an instructor-uploaded video, a case study, a link to an article, or other content. The content 212 may have any suitable format, such as text, video, audio, or images and may be selected by an instructor (e.g., the instructor 110) from any suitable content source or generated by the instructor. Alternatively, the content 212 may be selected or generated by one or more learners (e.g., the learners 112) or other individuals. The questions 214 may include closed-ended questions and/or open-ended questions provided by the instructor. The input 216 may include responses to the questions 214 input by the learners. In some instances, the input 216 from some learners may be presented to another learner or learners as peer responses.

The user accounts 118 may include one or more learner accounts 218 and one or more instructor accounts 220. With combined reference to FIGS. 1 and 2, each of the learners 112 may have a corresponding one of the learner accounts 218 and each of the instructors 110 may have a corresponding one of the instructor accounts 220. In some cases, an individual may qualify as both a learner and an instructor and may therefore have both one of the learner accounts 218 and one of the instructor accounts 220. Each of the user accounts 118 (including each of the learner accounts 218 and each of the instructor accounts 220) may include one or more of identification information for a corresponding user, authentication information to authenticate the corresponding user for access to the application 116 and/or the learning materials 114, responses to questions provided by the corresponding user while interacting with the application 116, evaluations or grades or comments from other users, data indicating one or more online courses in which the corresponding user is enrolled, data indicating one or more exercises within each online course that the corresponding user has completed and/or has not completed, or any other suitable information.

Alternatively or additionally, each of the user accounts 118 may indicate a level, type, or amount of access of the corresponding user to the application 116 and/or the learning materials 114. For example, each of the instructor accounts 220 may indicate or allow access by the corresponding instructor 110 to functionality of the application 116 to create exercises (each made up of particular content 212 and questions 214), to view input 216 provided by all learners 112 in an online course of the instructor 110, to provide grades or evaluations or feedback to each of the learners 112 in the online course, or other functionality that may be inaccessible to the learners 112. As another example, each of the learner accounts 218 may indicate or allow access to only those learning materials 114 that are associated with particular online courses in which the learners 112 have enrolled.

The communication interface 204 transmits and receives data to and from the client devices 104 and any other entities of the operating environment 100 of FIG. 1. In some implementations, the communication interface 204 includes a port for direct physical connection to the network 102 of FIG. 1 or to another communication channel. For example, the communication interface 204 may include a universal serial bus (USB) port, a secure digital (SD) port, a category 5 cable (CAT-5) port, or similar port for wired communication with the client devices 104 or any other entities of FIG. 1. In some implementations, the communication interface 204 includes a wireless transceiver for exchanging data with at least one of the client devices 104 or any other entities of FIG. 1 or other communication channels using one or more wireless communication methods, including IEEE 802.11, IEEE 802.16, BLUETOOTH®, or another suitable wireless communication method.

In some implementations, the communication interface 204 includes or is communicatively coupled to a cellular communications transceiver for sending and receiving data over a cellular communications network including via short messaging service (SMS), multimedia messaging service (MMS), hypertext transfer protocol (HTTP), direct data connection, wireless application protocol (WAP), e-mail, or another suitable type of electronic communication. In some implementations, the communication interface 204 includes a wired port and a wireless transceiver. The communication interface 204 may also provide other connections to the network 102 of FIG. 1 for distribution of files or media objects using standard network protocols including transmission control protocol/internet protocol (TCP/IP), HTTP, HTTP secure (HTTPS), and simple mail transfer protocol (SMTP), etc.

The storage 206 may include a non-transitory storage medium that stores instructions and/or data that may be executed and/or operated on by the processor device 202 to provide the functionality described herein. The instructions and/or data may be executed and/or operated on line-by-line by the processor device 202 and/or may be loaded into the memory 208 before being executed or operated on. The storage 206 may include a dynamic random access memory (DRAM) device, a static random access memory (SRAM) device, flash memory, or some other memory devices. In some implementations, the storage 206 also includes a non-volatile memory or similar permanent storage and media including a hard disk drive, a floppy disk drive, a CD-ROM device, a DVD-ROM device, a DVD-RAM device, a DVD-RW device, a flash memory device, or some other mass storage for storing information on a more permanent basis. The storage 206 may also store instructions and/or data that are temporarily stored or loaded into the memory 208.

As illustrated in FIG. 2, the application 116 may include at least one of: a learner interface module 222, a learner grades module 224, an exercise entry module 226, and an assessment module 228, collectively referred to herein as “modules 230”. The application 116, including the modules 230, may generally include software that includes programming code and/or computer-readable instructions executable by the processor device 202 to perform or control performance of the functions and operations described herein. The application 116, including one or of the modules 230, may send data to and/or receive data from another one of the components of the system 200 and may store received data in one or both of the storage 206 and the memory 208.

The exercise entry module 226 may generally be configured to facilitate the creation and editing of exercises by instructors for inclusion in the learning materials 114. Each exercise may include at least some content 212 and a question 214. The exercise entry module 226 may provide and/or generate an interface for instructors to create and edit such exercises. The exercise entry module 226 may additionally save any data entered by the instructor while creating or editing such exercise in the learning materials 114.

FIG. 3A is a graphic of an example interface 302A to create and/or edit an exercise, arranged in accordance with at least one embodiment described herein. The interface 302A may be provided and/or generated by the exercise entry module 226. The interface 302A may be stored, e.g., on the server 106 of FIG. 1 and/or the device 200 of FIG. 2, as a web page or web pages that may be loaded into a browser or other application on a client device associated with the instructor, to be displayed to the instructor. The interface 302A may be provided in its entirety in a single web page or may be spread across multiple web pages.

In general, the interface 302A may include one or more sections 304A-304F (collectively “sections 304”) in which the instructor may enter options, content, questions, or other information for inclusion in or otherwise associated with an exercise that the instructor is creating or editing. In the embodiment of FIG. 3A, there are six sections 304, each of which will be discussed in turn. The sections of FIG. 3A and in other Figures may or may not each be demarcated with an outline as in FIG. 3A and the other Figures and some sections may overlap with other sections. The outlines of the sections in the Figures merely indicate that there may be areas of the corresponding interface in which information may be output to an instructor or learner and/or input by an instructor or learner.

In section 304A, the instructor may enter one or more options. For instance, the instructor may enter one or more of a name of the exercise, whether the exercise is active (e.g., visible to learners), whether to anonymize responses of other learners that may be presented to a learner taking the exercise, whether to show responses of other learners that agree with the learner taking the exercise and a number of such responses to show, whether to show responses of other learners that disagree with the learner taking the exercise and a number of such response to show, an evaluation tool format for any responses of other learners shown to the learner, or other options. Accordingly, the section 304A may include one or more text fields, radio buttons, drop-down menus, or other graphical input elements through which the instructor may enter the options. More generally, each of the sections 304 may include one or more text fields, radio buttons, drop-down menus, or other graphical input elements through which the instructor may enter the corresponding information.

In section 304B, the instructor may enter content or links to content. The content may include an exercise from a textbook, video or audio content uploaded by the instructor or embedded from an online source, a case study, a link to an article, or other content. The content or links to content entered by the instructor may be saved as part of the content 212 in the learning materials 114.

In section 304C, the instructor may enter a first question, generally a closed-ended or categorical question with at least two possible discrete answers. The first question may not necessarily have a correct answer, but may be a matter of opinion. The at least two possible discrete answers to the first question may include, in some instances, at least one of the following pairs of answers: yes/no, agree/disagree, or A/B. The instructor may enter the possible discrete answers in section 304C.

In section 304D, the instructor may enter a second question. The second question may request a justification of whichever discrete answer is chosen in response to the first question. The first and second questions entered in sections 304C and 304D, respectively, may be designed to force a learner to choose a side (e.g., one of the at least two possible discrete answers to the first question) and defend (e.g., justify) it.

In section 304E, the instructor may enter instructions to the learner to read and evaluate one or more peer responses that will be presented to the learner after the learner answers the first and second questions. The instructions may alternately or additionally relate to how to evaluate the peer responses. For example, the instructions may indicate that the learner should rate the peer responses according to a scale or rating system described in the instructions.

In section 304F, the instructor may enter instructions to the learner to react to the peer responses. For example, the instructions may ask the learner to defend the learner's position in view of the peer responses or to respond to questions such as “what do you think of your peers' responses,” “what points do you agree with or disagree with and why,” or other questions. Alternately or additionally, the instructions may instruct the learner to reconsider his/her prior response to the closed-ended question, e.g., in view of the peer responses.

The information entered in sections 304B-304F may form a single learning iteration within the exercise. The interface 302A may allow the instructor to add learning iterations by providing additional sections 304B-304F (or a subset thereof) for each learning iteration. Alternatively or additionally, the interface 302A may allow the instructor to edit or delete each of the sections 304.

Returning to FIG. 2, the learner interface module 222 may generally be configured to administer exercises to the learners. The exercises may be created by instructors, as already discussed with respect to the exercise entry module 226 and the interface 302A of FIG. 3A. The learner interface module 222 may administer exercises to the learners by providing and/or generating one or more interfaces to output, to each learner taking an exercise, the particular content 212 and questions 214 designated by the instructor for that exercise. The learner interface module 222 may additionally administer exercises to learners by identifying peer responses from other learners that agree and/or disagree with input received from a learner taking the exercise or that present a different perspective than the learner's and presenting one or more of such peer responses to the learner through the interfaces provided and/or generated by the learner interface module 222. The learner interface module 222 may additionally administer exercises to learners by collecting and saving input entered through such interfaces, e.g., as input 216 and/or as data within a corresponding one of the user accounts 218.

FIGS. 3B-3E are graphics of example interfaces 302B-302E to administer exercises to learners, arranged in accordance with at least one embodiment described herein. Each of the interfaces 302B-302E may be provided and/or generated by the learner interface module 222. The interfaces 302B-302E may each be stored, e.g., on the server 106 of FIG. 1 and/or the device 200 of FIG. 2, as a web page or web pages that may be loaded into a browser or other application on a client device associated with the learners, to be displayed to the learners. Each of the interfaces 302B-302E may be populated by the learner interface module 222 with content 212, questions 214, and/or other data from the memory 208 of FIG. 2.

The interface 302B of FIG. 3B is an example of a home page that may be presented to a learner after logging in to the application 116 of FIG. 1 or 2. The information presented to each learner in the interface 302B may include one or more of a course number and/or name of a course in which the learner is participating, one or more exercises associated with each course, one or more graded exercises for each exercise or other information. In some embodiments, check marks or other graphic elements may indicate that an exercise has been completed by the learner and/or graded by the instructor. After selection by the learner of one of the exercises (e.g., exercise 1) from the interface 302B, the learner interface module 222 of FIG. 2 may present the interface 302C of FIG. 3C to the learner.

The interface 302C of FIG. 3C includes one or more sections 306A-306E within which information may be presented to the learner and/or input may be entered by the learner. In section 306A, content is presented to the learner. The content in section 306A includes the content entered by the instructor, e.g., in section 304B of the interface 302A of FIG. 3A, and may be part of a particular learning iteration of the exercise.

In section 306B, a first question is presented to the learner. The first question may include a closed-ended question and may include at least two possible discrete answers. The first question in section 306B includes the first question entered by the instructor, e.g., in section 304C of the interface 302A of FIG. 3A, and may be part of the same learning iteration of the exercise as the content in section 306A.

Section 306C includes an input area where the learner may input an answer to the first question of section 306B. For convenience, the answer to the first question may be referred to as the first answer. Insofar as the first question includes discrete answers, section 306C may include one or more radio buttons or a drop down menu that limit the learner's input of the first answer to selection of one of the possible discrete answers. The possible discrete answers include the possible discrete answers entered by the instructor, e.g., in section 304C of the interface 302A of FIG. 3A. The first answer may be saved by the learner interface module 222 of FIG. 2 to the input 216 and/or to the learner's learner account 218.

In section 306D, a second question is presented to the learner. The second question may request justification of the first answer. For instance, the second question may ask the learner to explain why the learner chose a particular one of the discrete answers to the first question over a different one of the discrete answers. The second question in section 306D includes the second question entered by the instructor, e.g., in section 304D of the interface 302A of FIG. 3A, and may be part of the same learning iteration of the exercise as the content in section 306A.

Section 306E includes an input area where the learner may input an answer to the second question of section 306D. For convenience, the answer to the second question may be referred to as the second answer. Section 306E may include a text entry area for the learner to type the second answer. The second answer may be saved by the learner interface module 222 of FIG. 2 to the input 216 and/or to the learner's learner account 218 in association with the first answer.

After receiving the first and second answers in sections 306C and 306E and optionally other input from the learner effective to indicate the learner is ready to proceed, the learner interface module 222 of FIG. 2 may save the first and second answers to the input 216 and/or to the learner's learner account 218. The learner interface module 222 may additionally identify, e.g., within the input 216 and/or other learner's learner accounts 218, peer responses from other learners that agree and/or disagree with the learner's first and second answers or that otherwise offer a different perspective than the learner's first and second answers. For example, the learner interface module 222 may find, within the input 216 and/or another learner's learner account 218, a second answer of the other learner that is associated with a first answer of the other learner that is the same or different as the first answer of the learner taking the exercise. In some embodiments, the learner interface module 222 may specifically identify at least one second answer that is associated with at least one first answer that is different than or disagrees with the learner's first answer to present the learner with a different or contrary viewpoint. Such peer responses identified by the learner interface module 222 may be presented to the learner within the interface 302D of FIG. 3D. The number of such peer responses is determined by the instructor when the exercise is created and may be entered by the instructor, e.g., in section 304A of FIG. 3A.

The interface 302D of FIG. 3D includes one or more sections 308A-308C within which information may be presented to the learner and/or input may be entered by the learner.

In section 308A, the peer responses identified by the learner interface module 222 are presented to the learner. Section 308A additionally includes instructions 310 from the instructor to read and evaluate the presented peer responses. In this regard, each of the peer responses in FIG. 3D includes up and down icons or buttons associated with it, and the learner evaluates each peer response by selecting a corresponding one of the icons or buttons in accordance with the instructions. The instructions may be entered by the instructor during creation of the exercise, e.g., in section 304E of FIG. 3A, and may be part of the same learning iteration of the exercise as the content in section 306A of FIG. 3C. The up and down arrow icons in FIG. 3D are one example of an evaluation tool format which may be entered by the instructor during creation of the exercise, e.g., in section 304A of FIG. 3A. Other evaluation tool formats may include thumbs up and thumbs down icons or buttons, agree and disagree icons or buttons, drop down menus with two or more ratings (one of which may be selected for each peer response), or other evaluation tool formats.

In section 308B, instructions to react to the peer responses may be presented to the learner. The instructions may ask the learner to defend the learner's position in view of the peer responses or to respond to questions such as “what do you think of your peers' responses,” “what points do you agree with or disagree with and why,” or other questions. Alternately or additionally, the instructions may instruct the learner to reconsider his/her prior response to the closed-ended question, e.g., in view of the peer responses and to answer the first question again. The instructions may be entered by the instructor during creation of the exercise, e.g., in section 304F of FIG. 3A, and may be part of the same learning iteration of the exercise as the content in section 306A of FIG. 3C.

In section 308C, the learner may react as instructed in section 308B by providing suitable input. For instance, the learner may enter input in section 308C such as a response to any questions or other instructions in section 308B.

After receiving the learner's input in section 308C and optionally other input from the learner effective to indicate the learner is ready to proceed, the learner interface module 222 of FIG. 2 may save the input entered in section 308C to the input 216 and/or to the learner's learner account 218. The learner interface module 222 may then end the exercise or present the interface 302E of FIG. 3E with additional learning iterations designated by the instructor for inclusion in the exercise.

As illustrated in FIG. 3E, each learning iteration may include one or more of sections 312A-312H. Sections 312A-312H are similar to sections in FIGS. 3C and 3D except they relate to additional content. In particular, in section 312A, additional content is presented to the learner, similar to the presentation of content to the learner in section 306A of FIG. 3C. In section 312B, a closed-ended question related to the additional content is presented to the learner, similar to the presentation to the learner of the first question in section 306B of FIG. 3C. In section 312C, the learner may input an answer to the question of section 312B, similar to section 306C of FIG. 3C. In section 312D, a question requesting justification for the answer entered in section 312C is presented to the learner, similar to section 306D of FIG. 3C in which justification is requested for the answer entered in section 306C. In section 312E, the learner may input an answer to the question of section 312D, similar to section 306E of FIG. 3C in which the learner may input an answer to the second question of section 306D. In section 312F, peer responses, instructions to read and evaluate the peer responses, and an evaluation tool to evaluate the peer responses may be presented to the learner, similar to section 308A of FIG. 3D. In section 312G, instructions to react to the peer responses may be presented to the learner, similar to section 308B of FIG. 3D. In section 312H, the learner may react as instructed (e.g., by entering input), similar to section 308C of FIG. 3D.

Returning to FIG. 2, the assessment module 228 may generally be configured to facilitate instructor assessment of exercises completed by learners. For instance, the assessment module 228 may collect and/or organize some or all of the input entered by a learner for each exercise along with peer responses viewed by the learner during each exercise. Alternately or additionally, the assessment module 228 may provide and/or generate one or more interfaces to output to the instructor the learner input and peer responses associated with each exercise completed by each learner and to accept an evaluation, grade, comment, or other feedback from the instructor regarding the learner's input. For instance, the assessment module 228 may provide such an interface using information collected by the assessment module 228 from, e.g., the input 216 and/or the learner accounts 218 of FIG. 2.

FIG. 3F is a graphic of an example interface 302F to facilitate instructor assessment of exercises completed by learners, arranged in accordance with at least one embodiment described herein. The interface 302F may be provided and/or generated by the assessment module 228. The interface 302F may be stored, e.g., on the server 106 of FIG. 1 and/or the device 200 of FIG. 2, as a web page or web pages that may be loaded into a browser or other application on a client device associated with the instructor, to be displayed to the instructor. In this example, the web page may be populated with information collected by the assessment module 228 from the input 216 and/or the learner accounts 218.

The interface 302F of FIG. 3F includes an exercise-specific and learner-specific assessment interface in which the instructor generally sees some or all of what the learner saw when completing the exercise and additionally sees the learner's responses. For instance, the interface 302F may present to the instructor questions 214 and peer responses presented to a learner during a given exercise along with the learner's input 216 in response to the questions 214. Such exercise-specific and student-specific interfaces may be generated for each learner for each exercise that the learner has completed.

In more detail, the interface 302F includes various sections 314A-314J. Section 314A includes the first question in a learning iteration of the exercise. In this regard, the section 314A includes the same first question as the section 306B of FIG. 3C (or the section 312B of FIG. 3E). Section 314B includes the learner's response to the first question, e.g., one of the discrete answers to the first question selected by the learner in response to the first question as inputted into section 306C of FIG. 3C or section 312C of FIG. 3E. Section 314C includes the second question in the learning iteration of the exercise. In this regard, section 314C includes the same second question as section 306D of FIG. 3C (or section 312D of FIG. 3E).

Section 314D includes the learner's response to the second question, e.g., a justification for the learner's response to the first question. In particular, section 314D may include the learner's response to the second question as inputted into section 306E of FIG. 3C or section 312E of FIG. 3E. Section 314E includes ratings (e.g., evaluations) from other learners of the learner's second answer, e.g., evaluations provided by the other learners when the learner's second answer was presented to the other learners as a peer response while the other learners were completing the exercise. Section 314F includes peer responses of other learners viewed by the learner. In this regard, section 314F includes the same peer responses as section 308A in FIG. 3D (or section 312F in FIG. 3E).

Section 314G includes instructions to react to the peer responses of section 314F. In this regard, section 314G includes the same instructions as section 308B of FIG. 3D (or section 312G in FIG. 3E). Section 314H includes the learner's response to the instructions of section 3134G. In particular, section 314H may include input from the learner inputted into section 308C of FIG. 3D or section 312H of FIG. 3E.

Section 314I represents the possibly inclusion of questions and input for additional learning iterations of the exercise. For instance, section 314I may in reality include multiple sections, including, for each additional learning iteration, a closed-ended question (e.g., the same closed-ended question as in section 312B of FIG. 3E), the learner's response to the closed-ended question (e.g., as input through section 312C of FIG. 3E), a second question requesting justification therefor (e.g., the same question as in section 312D of FIG. 3E), peer responses to the second question viewed and evaluated by the learner (e.g., the peer responses presented in section 312F of FIG. 3E), instructions to react to the peer responses (e.g., the instructions as in section 312G of FIG. 3E), and the learner's reaction to the peer responses (e.g., as input through section 312H of FIG. 3E).

Section 314J includes one or more input areas for the instructor to input one or more of a grade and other feedback. Each of the input areas in section 314J may include a text box. The instructor may save the grade and any other feedback by clicking the illustrated “Save” button or providing other input effective to save the instructor's grade or other feedback. The instructor's grade or other feedback may be saved, e.g., by the assessment module 228 to a corresponding one of the learner accounts 218 in FIG. 2. Optionally, the interface 302F may further include a button 316 or other graphical interface element that takes the instructor back to a listing of learners, the selection of any one of which may lead the instructor to the interface 302F of FIG. 3F for the selected learner.

FIG. 3G is a graphic of another example interface 302G to facilitate instructor assessment of exercises completed by learners, arranged in accordance with at least one embodiment described herein. The interface 302G may be provided and/or generated by the assessment module 228. The interface 302G may include a file that includes a grid with various columns 318A-318J. The interface 302G may be generated by the assessment module 228 on demand and may be populated with information collected by the assessment module 228 from the input 216 and/or the learner accounts 218. Alternatively of additionally, the interface 302G may be presented as a web page or web pages.

The interface 302G may be an exercise-specific interface with input 216 from all of the learners that have completed the corresponding exercise. In FIG. 3G, the first column 318A identifies the first name of each learner. The second column 3318B identifies the last name of each learner. The third column 318C identifies a section (e.g., one of multiple sections of the same course) to which the corresponding learner belongs. The fourth column 318D identifies a username of the corresponding learner.

The fifth column 318E includes a grade awarded by the instructor to the corresponding learner for the exercise. The sixth column 318F includes feedback provided by the instructor to the learner for the exercise. In some instances, the grade and/or feedback appears in one or more of the cells of the fifth and sixth columns 318E and 318F if the instructor has already entered the grade and the feedback, e.g., through section 314J of the interface 302F of FIG. 3F. Alternatively or additionally, the instructor may input the learner's grade and/or feedback in one or more of the cells of the fifth and sixth columns 318F and 318G, which grade and/or feedback may then be saved by the assessment module 228 to the corresponding one of the learner accounts 218.

The seventh column 318G includes the learner's first answer to the first question or a representation thereof. For instance, where the first answer has binary discrete answers, the seventh column 318G may include a 0 to indicate selection by the learner of a first one of the binary discrete answers or a 1 to indicate a selection by the learner of a second one of the binary discrete answers. The eighth column 318H includes the learner's second answer to the second question or the learner's reaction to the peer responses. In this regard, an answer in the eighth column 318H that is on the same row as the first answer in the seventh column 318G may include the second answer to the second question, while an answer in the eighth column 318H that is on the next row (or a different row) as the first answer in the seventh column 318G may include the learner's reaction to the peer responses.

The ninth column 318I may include evaluations (e.g., ratings) by other learners of the learner's second answer in the eighth column 318H when the learner's second answer was viewed by the other learners as a peer response during completion of the exercise by the other learners. In the present embodiment, a 5 in the ninth column 318I may indicate that a corresponding one of the other learners rated the learner's second answer by giving it a thumbs up or up arrow, while a 1 may indicate that a corresponding one of the other learners rated the learner's second answer by giving it a thumbs down or down arrow. This is only way to represent the evaluations by other learners and other representations may be used instead or in addition thereto.

The tenth column 318J may include a completion date and time of the exercise by the learner.

As illustrated in FIG. 3G, not every cell of every column includes data. For example, the completion date and time of the tenth column 318J may only appear in the first row for the learner. The learner's second answers may only appear in the eighth column 318H in the same rows of the seventh column 318G that include one of the learner's first answers to the first questions. The learner's reactions to peer responses may only appear in the eighth column 318H in the row following the row that includes the learner's first answer.

Moreover, the second and third rows for the learner “Mallory Higgins” that include the learner's first answer in the seventh column 318G and second answer and reaction to peer responses in the eighth column 318H represent a single learning iteration. The interface 302G may include, for each learner, additional rows for each additional learning iteration included in the exercise. For example, if the exercise corresponding to the interface 302G includes two more learning iterations, the interface 302G may include at least four additional rows for the learner “Mallory Higgins,” including for each of the two iterations: (1) a first row with the learner's discrete answer (in the seventh column 318G) to a closed-ended question, the learner's justification (in the eighth column 318H) for the discrete answer, and evaluations (in the ninth column 318I) by other learners of the learner's justification, and (2) a second row with the learner's reaction to peer responses viewed by the learner for the corresponding iteration.

Returning to FIG. 2, the learner grades module 224 may generally be configured to collect, organize, and/or provide feedback to a learner for each exercise completed by the learner, where the feedback is from other learners and/or from the instructor. The feedback may include evaluations by other learners of at least some of the learner's input, such as of the learner's answer(s) entered in section 306E of FIG. 3C or in section 312E of FIG. 3E. Alternately or additionally, the feedback may include the instructor's score, grade, assessment, and/or other feedback entered in, e.g., section 314J of FIG. 3F. The learner grades module 224 may provide and/or generate one or more interfaces to output to the learner the feedback from the other learners and/or from the instructor. For instance, the learner grades module 224 may provide such an interface using information collected by the learner grades module 224 from, e.g., the input 216 and/or the learner accounts 218 of FIG. 2.

FIG. 3H is a graphic of an example interface 302H to provide feedback to a learner for each exercise completed by the learner, arranged in accordance with at least one embodiment described herein. The interface 302H may be provided and/or generated by the learner grades module 224. The interface 302H may be stored, e.g., on the server 106 of FIG. 1 and/or the device 200 of FIG. 2, as a web page or web pages that may be loaded into a browser or other application on a client device associated with the instructor, to be displayed to the instructor. In this example, the web page may be populated with information collected by the learner grades module 224 from the input 216 and/or the learner account 218.

In general, the interface 302H may include one or more sections 320A-320B in which feedback for a particular exercise may be presented to the learner. In section 320A, feedback from other learners may be presented to the learner. The feedback from other learners may include evaluations by other learners of the learner's second answer(s) (e.g., justification(s) for the learner's first answer(s)), as described herein. In section 320B, feedback from the instructor may be presented to the learner. The feedback from the instructor may include a grade, comments, or other feedback from the instructor.

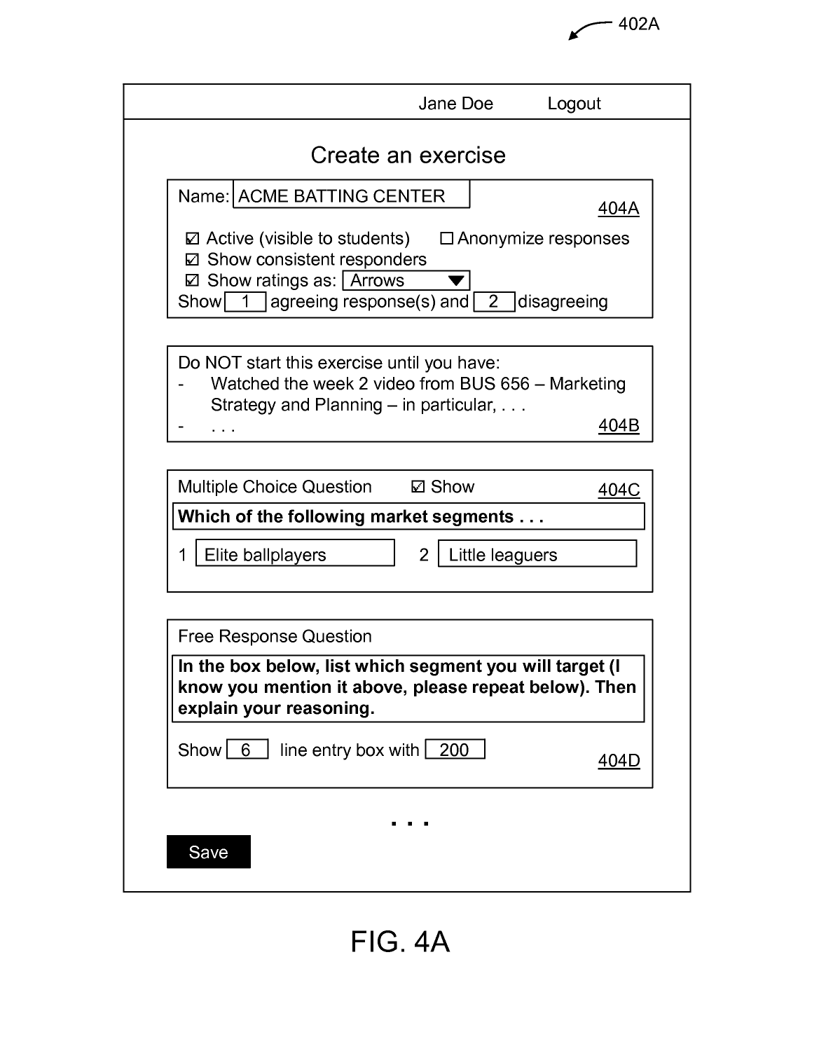

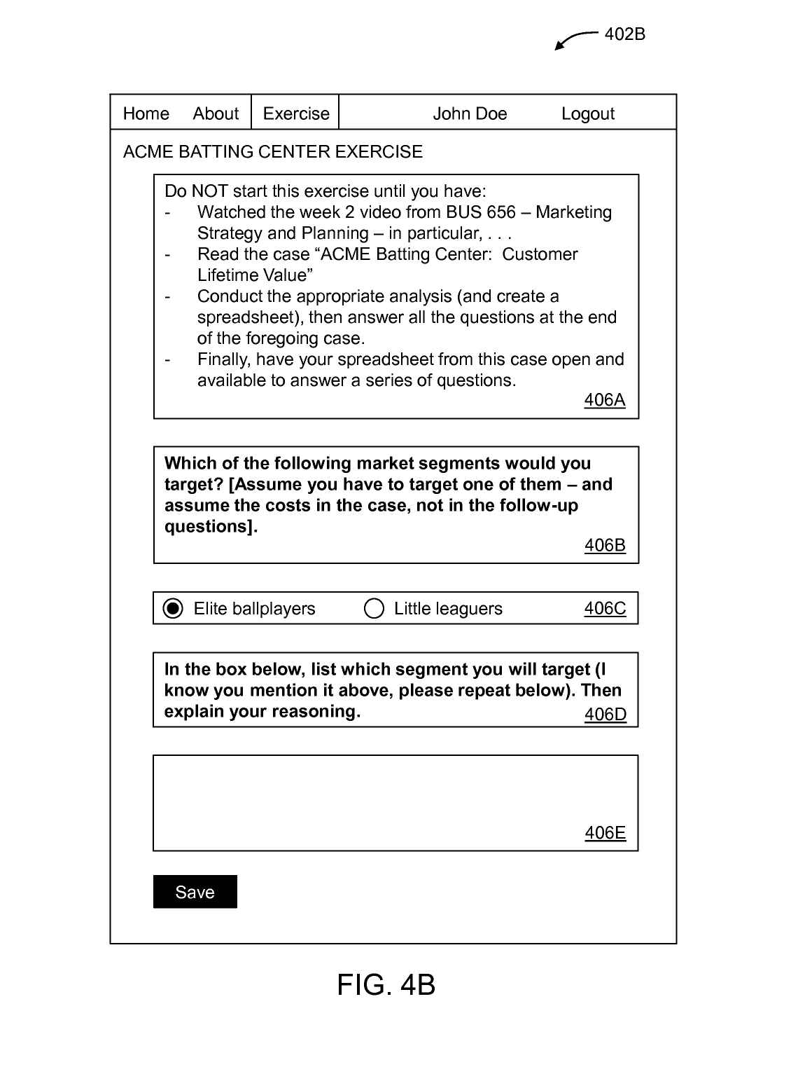

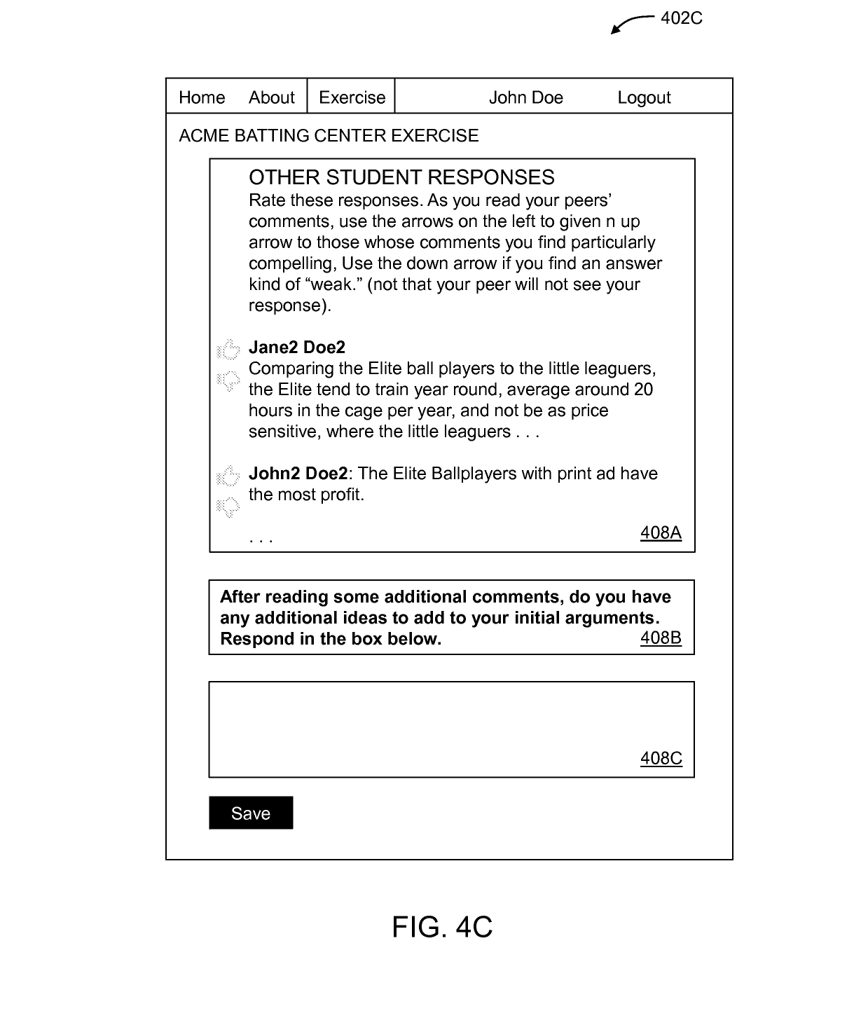

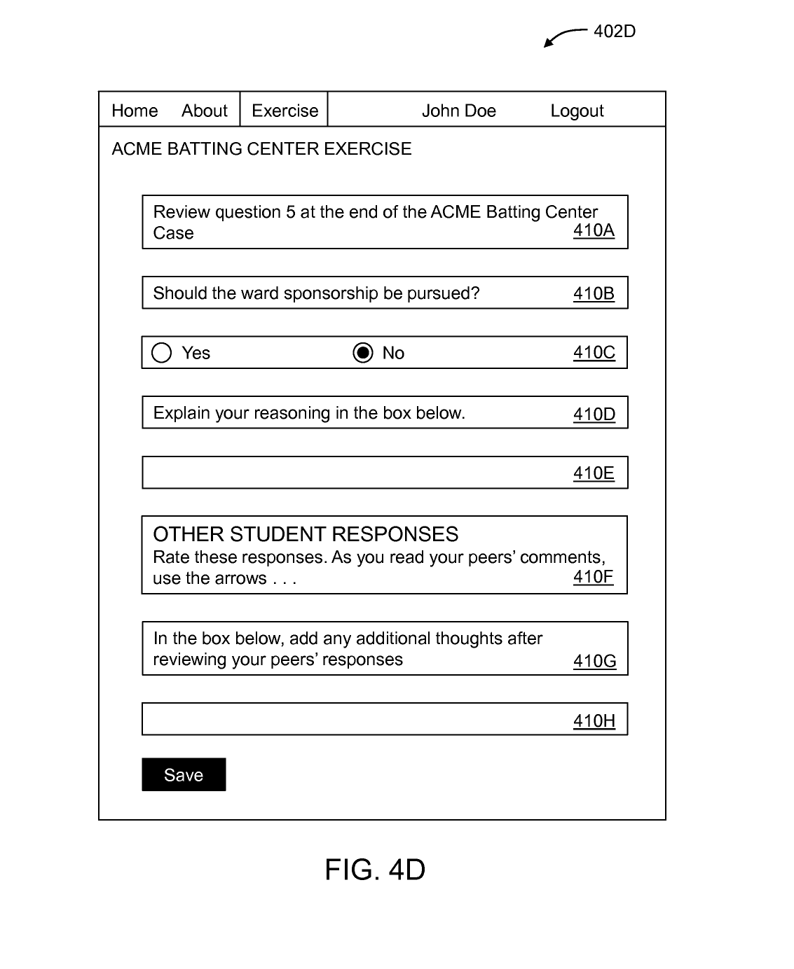

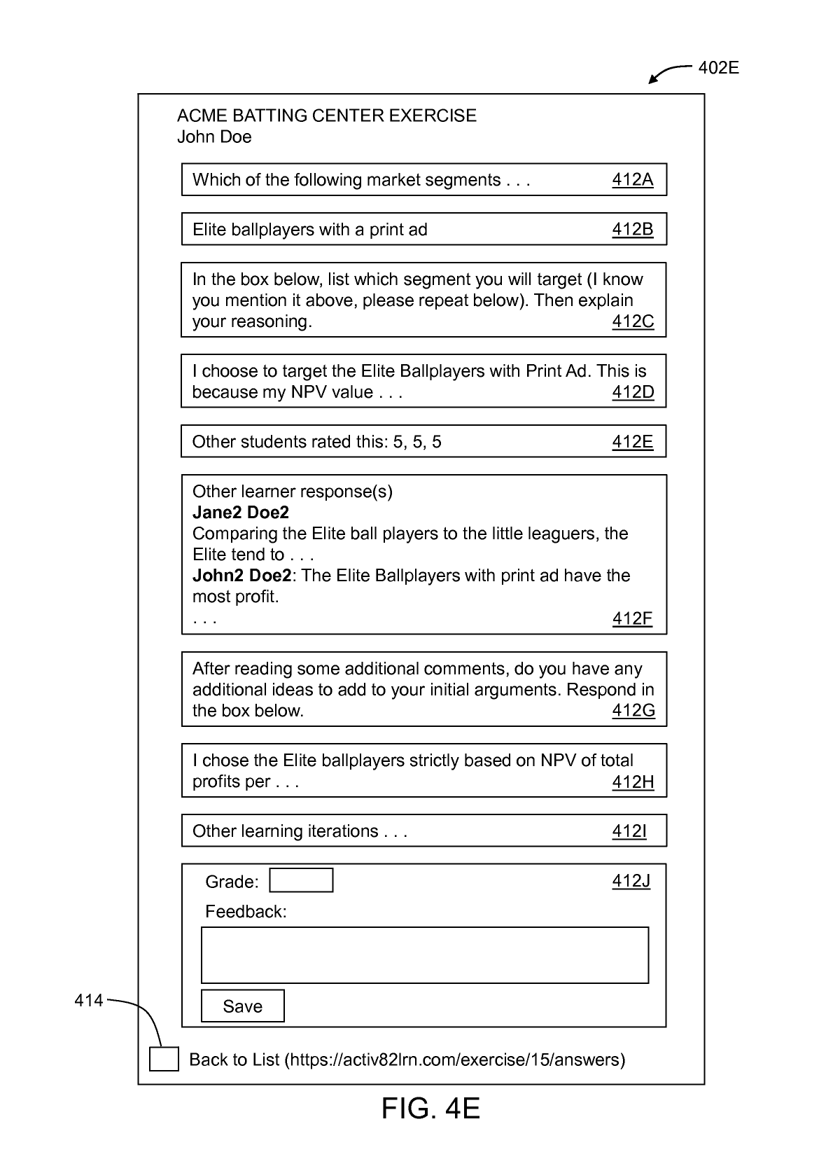

FIGS. 4A-4E are graphics of specific example implementations of some of the interfaces 302A-302H of FIGS. 3A-3H, arranged in accordance with at least one embodiment described herein. In particular, FIG. 4A is a graphic of an interface 402A that is an example implementation of the interface 302A of FIG. 3A and in which an instructor with a name or username “Jane Doe” is creating an exercise entitled ACME BATTING CENTER. The interface 402A of FIG. 4A includes sections 404A-404D that include example implementations of the sections 304A-304D of FIG. 3A. Additional sections may be provided in the interface 402A of FIG. 4A that correspond to the sections 304E and 304F of FIG. 3A to allow the instructor to complete creation of the exercise, but such additional sections have been omitted for brevity. Additionally, in FIG. 4A and other Figures herein, the use of ellipses “ . . . ” indicates the presence of one or more other client devices 104 (FIG. 1), sections (e.g., FIG. 3A), exercises (FIG. 3B), grades (FIG. 3B), text (e.g., FIGS. 3D and 4A), rows or other data (FIG. 3F), or other devices, components, or data, as context indicates. The instructor may save the ACME BATTING CENTER exercise or any edits thereto by clicking the illustrated “Save” button or providing other input effective to save the exercise.

FIG. 4B is a graphic of an interface 402B that is an example implementation of the interface 302C of FIG. 3C in which a learner with a name or username “John Doe” is beginning the ACME BATTING CENTER exercise created by the instructor through the interface 402A of FIG. 4A. The interface 402B of FIG. 4B includes sections 406A-406E that include example implementations of the sections 306A-306E of FIG. 3C. The learner may proceed to the next interface (e.g., in FIG. 4C) by clicking the illustrated “Save” button or providing other input effective to indicate completion of the interface 402B.

FIG. 4C is a graphic of an interface 402C that is an example implementation of the interface 302D of FIG. 3D in which the learner “John Doe” is continuing the ACME BATTING CENTER exercise started in FIG. 4B. The interface 402C of FIG. 4C includes sections 408A-408C that include example implementations of the sections 308A-308C of FIG. 3D. The learner may proceed to the next interface (e.g., in FIG. 4D) by clicking the illustrated “Save” button or providing other input effective to indicate completion of the interface 402C.

FIG. 4D is a graphic of an interface 402D that is an example implementation of the interface 302E of FIG. 3E in which the learner “John Doe” is continuing the ACME BATTING CENTER exercise started in FIG. 4B with at least one additional learning iteration. The interface 402D of FIG. 4D includes sections 410A-410H that include example implementations of the sections 312A-312H of FIG. 3E. The learner may proceed to a next interface and/or complete the exercise by clicking the illustrated “Save” button or providing other input effective to indicate completion of the interface 402D.

FIG. 4E is a graphic of an interface 402E that is an example implementation of the interface 302F of FIG. 3F in which an instructor is evaluating the learner “John Doe” with respect to the ACME BATTING CENTER exercise. The interface 402E includes sections 412A-412J and button 414 that include example implementations of the sections 314A-314J and the button 316 of FIG. 3F. The instructor may review the interface 402E to see, e.g., the questions and peer responses presented to “John Doe” and the responses and reactions of “John Doe” to the questions and peer responses. The interface 402E also allows the instructor to give “John Doe” a grade and comments or other feedback based at least on the responses and reactions of “John Doe.”

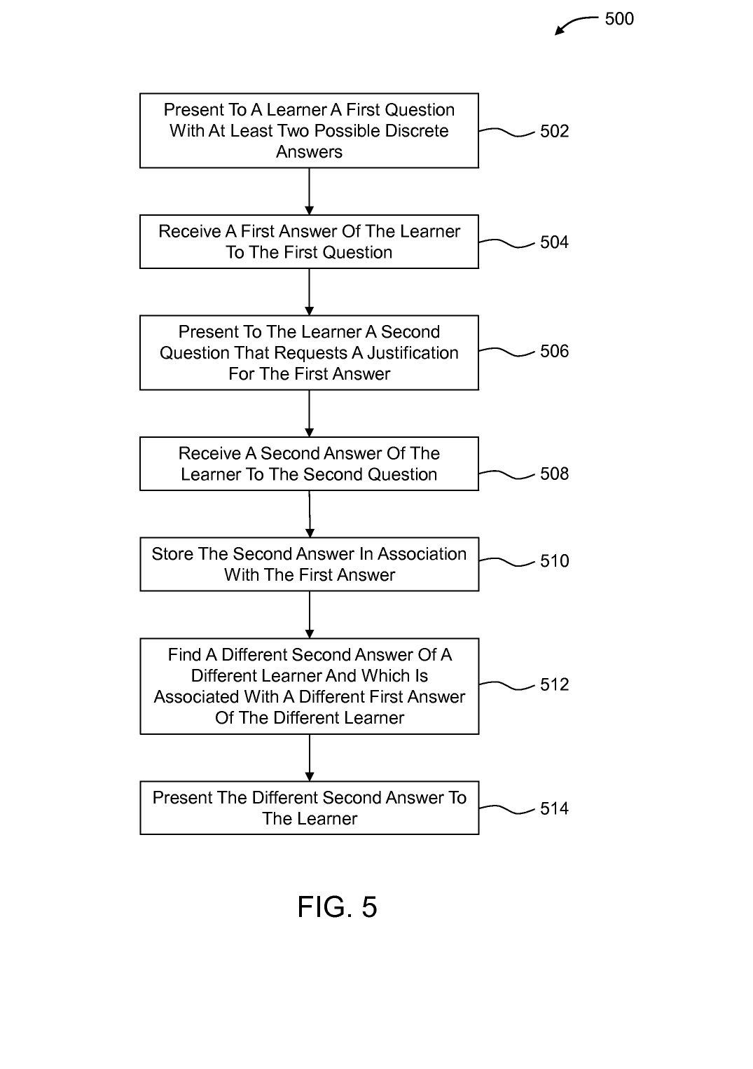

FIG. 5 shows an example flow diagram of a method 500 to provide active learning in an asynchronous online setting, arranged in accordance with at least one embodiment described herein. The method 500 may be implemented, in whole or in part, by one or more of the server 106 of FIG. 1 or the device 200 of FIG. 2 executing the application 116. The method may begin at block 502 and is discussed in the context of FIGS. 1-3H with the assumption that the learner 112A is doing an exercise using the client device 104B.

At block 502, a first question with at least two possible discrete answers may be presented to the learner 112A. The first question may be related to content that is presented to the learner through the client device 104B. The first question may be presented to the learner through the client device 104B by, e.g., the learner interface module 222 sending the interface 302C of FIG. 3C, including section 306B and/or 306C, to the client device 104B to be displayed to the learner 112A.

At block 504, a first answer of the learner 112A to the first question may be received. The first answer may include a selection by the learner of one of the discrete answers to the first question. The first answer may be entered by the learner 112A into, e.g., section 306C of FIG. 3C using an input device of the client device 104B and may eventually be sent by the client device 104B to the learner interface module 222 to be saved by the learner interface module 222 as the input 216 and/or to a corresponding one of the learner accounts 218.

At block 506, a second question that requests justification for the first answer may be presented to the learner 112A. The second question may be presented to the learner 112A through the client device 104B by, e.g., the learner interface module 222 sending the interface 302C of FIG. 3C, including section 306D and/or 306E, to the client device 104B to be displayed to the learner 112A.

At block 508, a second answer of the learner 112A to the second question may be received. The second answer may include a justification of the learner 112A for the first answer of the learner 112A to the first question. The second answer may be entered by the learner 112A into, e.g., section 306E of FIG. 3C using an input device of the client device 104B and may eventually be sent by the client device 104B to the learner interface module 222 to be saved by the learner interface module 222 as the input 216 and/or to a corresponding one of the learner accounts 218. In some implementations, the first and second answers may not be sent to the learner interface module 222 until the learner 112A selects a “Save” button in the interface in which the first and second questions are presented or provides other suitable input to indicate that the learner 112A has completed the interface.

At block 510, the second answer may be stored in association with the first answer in, e.g., the input 216 and/or the learner account 218 of the learner 112A. The second answer may be stored in association with the first answer by the learner interface module 222. The second answer may be associated with the first answer such that it can be subsequently used as a peer response for other learners 112 doing the exercise and can more readily be identified as agreeing with or disagreeing with second answers of other learners 112. In this regard, since the second answers can generally include a free text response of the corresponding learners 112, it may be difficult to identify second answers that agree with or disagree with a given second answer. However, it may be relatively easy to identify first answers that agree with or disagree with a given first answer since the first answers are limited to discrete answers. Accordingly, comparison of the first answers to identify those that agree or disagree with a given first answer may be used as a proxy to identify second answers that agree with or disagree with a corresponding second answer associated with the given first answer.

At block 512, a different second answer (e.g., a peer response) of a different learner 112 (or other learners 112) to the second question and which is associated with a different first answer of the different learner 112 to the first question may be found in, e.g., the input 216 and/or one or more of the learner accounts 218. The different first answer and the different second answer of the different learner 112 may agree or disagree with the first answer and the second answer of the learner 112A. The different second answer may be found by the learner interface module 222 by using the different first answer with which the different second answer is associated as a proxy to determine whether the different second answer agrees or disagrees with the second answer of the learner 112A.

At block 514, the different second answer may be presented to the learner 112A. The different second answer may be presented to the learner 112A through the client device 104B by, e.g., the learner interface module 222 sending the interface 302D of FIG. 3D, including section 308A, to the client device 104B to be displayed to the learner 112A. In some embodiments, block 506 and/or block 514 may occur after block 504.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed implementations.

For example, the method 500 may additionally include asking the learner 112A through the client device 104B to read the different second answer and provide an evaluation of the different second answer. The foregoing may be accomplished by the learner interface module 222 sending the interface 302D of FIG. 3D, including the instructions 310, to the client device 104B to be displayed to the learner 112A.

The method 500 may additionally include receiving the evaluation from the client device 104B and storing it in the input 216 and/or the corresponding learner account 218 of the learner 112A. The receipt and storing of the evaluation may be performed by the learner interface module 222.

The method 500 may additionally include instructing the learner 112A to react to the different second answer by, e.g., presenting the first question to the learner 112A again with instructions to reconsider the first question and answer it again, e.g., with the same first answer or a modified first answer. Alternately or additionally, the instructions to react to the different second answer may ask the learner 112A to defend the position represented by the first answer, the same first answer, or the modified first answer in view of the different second answer or other peer responses presented to the learner 112A, or to answer questions such as “what do you think of your peers' responses,” “what points do you agree with or disagree with and why,” or other questions. The responses of the learner 112A to the instructions to react to the different second answer may include the same first answer, the modified first answer, or other input in response to the instructions to react, some or all of which may be saved by the learner interface module 222 as the input 216 and/or to the corresponding one of the learner accounts 218.

In some embodiments, the evaluations provided by the learners 112 of second answers of other learner's 112 as the learners 112 do the exercise may be used in the method 500 to filter the second answers that are presented to the earner 112A as the learner 112A does the exercise. For instance, in addition to selecting second answers to present to the learner 112A based on whether the second answers agree or disagree with the second answer of the learner 112A, the second answers may be selected based on whether they have higher (or better) evaluations than other second answers.

The method 500 may also include receiving an evaluation of the second answer of the learner 112A by other learners 112 and/or by the instructor 110, and optionally other feedback from the instructor 110. Feedback including the evaluation by the other learners 112, the evaluation by the instructor 110, and/or the other feedback of the instructor 110 may be presented to the learner 112A. The feedback may be collected, organized, and/or provided to the learner 112A by the learner grades module 224. In some embodiments, the feedback may be provided to the learner 112A by the learner grades module 224 sending the interface 302H of FIG. 3H, including the section 320A and/or 320B, to the client device 104B to be displayed to the learner 112A.

The method 500 may also include presenting an interface to the instructor 110 to evaluate the second answer and/or other input of the learner 112A. For instance, the assessment module 228 may create and/or send the interface 302F of FIG. 3F to the client device 104A to be displayed to the instructor 110. The instructor 110 may evaluate the second answer and/or provide other feedback by entering the evaluation or other feedback in a corresponding column or section of the interface 302F using an input device of the client device 104A, which input may be sent by the client device 104A to the assessment module 228 to be saved to the learner account 218 of the learner 112A.

The implementations described herein may include the use of a special purpose or general purpose computer including various computer hardware or software modules, as discussed in greater detail below.

Implementations described herein may be implemented using computer-readable media for carrying or having computer-executable instructions or data structures stored thereon. Such computer-readable media may be any available media that may be accessed by a general purpose or special purpose computer. By way of example, and not limitation, such computer-readable media may include non-transitory computer-readable storage media including RAM, ROM, EEPROM, CD-ROM or other optical disk storage, magnetic disk storage or other magnetic storage devices, or any other storage medium which may be used to carry or store desired program code in the form of computer-executable instructions or data structures and which may be accessed by a general purpose or special purpose computer. Combinations of the above may also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the term “module” or “component” may refer to software objects or routines that execute on the computing system. The different components, modules, engines, and services described herein may be implemented as objects or processes that execute on the computing system (e.g., as separate threads). While the system and methods described herein are preferably implemented in software, implementations in hardware or a combination of software and hardware are also possible and contemplated. In this description, a “computing entity” may be any computing system as previously defined herein, or any module or combination of modulates running on a computing system.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

That which is claimed:

1. A method comprising:
presenting to an online learner a first question with at least two possible discrete answers;
receiving a first answer of the online learner to the first question;
presenting to the online learner a second question that requests a justification for the first answer;
receiving a second answer of the online learner to the second question;
storing, in a learner account of the online learner the second answer in association with the first answer;
finding a different second answer of a different online learner and which is associated with a different first answer of the different online learner, wherein the different first answer and the different second answer disagree with the first answer and the second answer of the online learner or present a different perspective than the first answer and the second answer; and
presenting the different second answer to the online learner.

2. The method of claim 1, further comprising:
asking the online learner to read the different second answer and provide an evaluation of the different second answer;
receiving and storing the evaluation of the different second answer in association with the different second answer; and
storing evaluations by other online learners of other second answers and in association with the other second answers;
wherein finding the different second answer comprises finding one of the other second answers that disagrees with the second answer of the online learner and that has higher evaluations than at least some of the other second answers.

3. The method of claim 1, further comprising, after presenting the different second answer to the online learner:
presenting the first question to the online learner again with an explanation that the online learner may modify the first answer and with instructions to answer the first question again; and
receiving a same first answer of the online learner as before or a modified first answer of the online learner.

4. The method of claim 3, further comprising, presenting to the online learner a third question that asks the online learner to defend, justify, and/or explain the same first answer or the modified first answer in view of the different first answer and the different second answer that disagree with the first answer and the second answer.

5. The method of claim 1, further comprising:
finding another second answer of another online learner and associated with another first answer of the other online learner, wherein the other first answer and the other second answer agree with the first answer and the second answer of the online learner;
presenting the other second answer that agrees with the second answer to the online learner; and
asking the online learner to read and provide an evaluation of the other second answer.

6. The method of claim 1, further comprising:
prior to presenting the first question to the online learner, presenting content to the online learner, wherein the first question is related to the content;
after presenting the different second answer to the online learner, iteratively performing the following at least one time:
presenting to the online learner additional content;
presenting to the online learner a question related to the additional content, where the question related to the content has at least two possible discrete answers;
receiving an answer of the online learner to the question related to the additional content;
presenting to the online learner a question that requests justification for the answer to the question related to the additional content;
receiving a justification of the online learner for the answer to the question related to the additional content;
storing, in the learner account of the online learner, the justification in association with the answer to the question related to the additional content;
finding at least one other justification of at least one other online learner and that is associated with at least one other answer of the at least one other online learner to the question related to the additional content;
presenting the at least one other justification to the online learner; and
asking the online learner to read the at least one other justification and provide an evaluation of the at least one other justification.

7. The method of claim 1, further comprising:
receiving at least one evaluation by at least one other online learner of the second answer of the online learner;
storing the at least one evaluation in association with the second answer;
receiving an evaluation by a course instructor of the second answer of the online learner; and
presenting to the online learner feedback on an exercise comprising the first and second questions, wherein the feedback includes the at least one evaluation by the at least one other online learner and the evaluation by the course instructor.

8. The method of claim 1, further comprising:
presenting to a course instructor an interface to evaluate the online learner's second answer;
receiving an evaluation by the course instructor of the online learner's second answer; and
presenting to the course instructor a grid with rows, wherein one of the rows includes a name of the online learner, the first answer, the second answer, an evaluation by the online learner of the different second answer of the different online learner, an evaluation of the second answer of the online learner by at least one other online learner; and the evaluation by the course instructor of the second answer of the online learner.

9. A non-transitory computer-readable medium that includes computer-readable instructions stored thereon that are executable by a processor to perform or control performance of operations comprising:
presenting to an online learner a first question with at least two possible discrete answers;
receiving a first answer of the online learner to the first question;
presenting to the online learner a second question that requests a justification for the first answer;
receiving a second answer of the online learner to the second question;
storing, in a learner account of the online learner the second answer in association with the first answer;
finding a different second answer of a different online learner and which is associated with a different first answer of the different online learner, wherein the different first answer and the different second answer disagree with the first answer and the second answer of the online learner or present a different perspective than the first answer and the second answer; and
presenting the different second answer to the online learner.

10. The non-transitory computer-readable medium of claim 9, the operations further comprising:
asking the online learner to read the different second answer and provide an evaluation of the different second answer;
receiving and storing the evaluation of the different second answer in association with the different second answer; and
storing evaluations by other online learners of other second answers and in association with the other second answers;
wherein finding the different second answer comprises finding one of the other second answers that disagrees with the second answer of the online learner and that has higher evaluations than at least some of the other second answers.

11. The non-transitory computer-readable medium of claim 9, the operations further comprising, after presenting the different second answer to the online learner:
presenting the first question to the online learner again with an explanation that the online learner may modify the first answer and with instructions to answer the first question again; and
receiving a same first answer of the online learner as before or a modified first answer of the online learner.

12. The non-transitory computer-readable medium of claim 11, the operations further comprising, presenting to the online learner a third question that asks the online learner to defend, justify, and/or explain the same first answer or the modified first answer in view of the different first answer and the different second answer that disagree with the first answer and the second answer.

13. The non-transitory computer-readable medium of claim 9, the operations further comprising:
finding another second answer of another online learner and associated with another first answer of the other online learner, wherein the other first answer and the other second answer agree with the first answer and the second answer of the online learner;
presenting the other second answer that agrees with the second answer to the online learner; and
asking the online learner to read and provide an evaluation of the other second answer.

14. The non-transitory computer-readable medium of claim 9, the operations further comprising:
prior to presenting the first question to the online learner, presenting content to the online learner, wherein the first question is related to the content;
after presenting the different second answer to the online learner, iteratively performing the following at least one time:
presenting to the online learner additional content;
presenting to the online learner a question related to the additional content, where the question related to the content has at least two possible discrete answers;
receiving an answer of the online learner to the question related to the additional content;
presenting to the online learner a question that requests justification for the answer to the question related to the additional content;
receiving a justification of the online learner for the answer to the question related to the additional content;
storing, in the learner account of the online learner, the justification in association with the answer to the question related to the additional content;
finding at least one other justification of at least one other online learner and that is associated with at least one other answer of the at least one other online learner to the question related to the additional content;
presenting the at least one other justification to the online learner; and
asking the online learner to read the at least one other justification and provide an evaluation of the at least one other justification.

15. The non-transitory computer-readable medium of claim 9, the operations further comprising:
receiving at least one evaluation by at least one other online learner of the second answer of the online learner;
storing the at least one evaluation in association with the second answer;
receiving an evaluation of the second answer of the online learner by a course instructor; and
presenting to the online learner feedback on an exercise comprising the first and second questions, wherein the feedback includes the at least one evaluation by the at least one other online learner and the evaluation by the course instructor.

16. The non-transitory computer-readable medium of claim 9, the operations further comprising:
presenting to a course instructor an interface to evaluate the online learner's second answer;
receiving an evaluation by the course instructor of the online learner's second answer; and
presenting to the course instructor a grid with rows, wherein one of the rows includes a name of the online learner, the first answer, the second answer, an evaluation by the online learner of the different second answer of the different online learner, an evaluation of the second answer of the online learner by at least one other online learner; and the evaluation by the course instructor of the second answer of the online learner.

17. A method comprising:
presenting content to an online learner through a client device associated with the online learner, wherein the online learner has a learner account stored in at least one non-transitory computer-readable medium;
presenting to the online learner through the client device a first question related to the content, wherein the first question has at least two possible discrete answers;
receiving from the client device a first answer of the online learner to the first question, wherein the first answer includes a first discrete answer from among the at least two possible discrete answers;
presenting to the online learner through the client device a second question that requests a justification for the first answer;
receiving from the client device a second answer of the online learner to the second question, wherein the second answer includes a justification of the online learner for the online learner's first answer to the first question;
storing, in the learner account of the online learner in the at least one non-transitory computer-readable medium, the second answer in association with the first answer;
finding in the at least one non-transitory computer-readable medium a different second answer of a different online learner in response to the second question, the different second answer being associated with a different first answer of the different online learner to the first question, wherein the different first answer and the different second answer disagree with the first answer and the second answer;
presenting the different second answer through the client device to the online learner.
asking the online learner through the client device to read the different second answer and provide an evaluation of the different second answer;
receiving the evaluation from the client device and storing the evaluation of the different second answer in the at least one non-transitory computer-readable medium in association with the different second answer;
presenting the first question to the online learner again through the client device with an explanation that the online learner may modify the first answer and with instructions to answer the first question again;
receiving from the client device a same first answer of the online learner as before or a modified first answer of the online learner; and
presenting to the online learner through the client device a third question that asks the online learner to defend, justify, and/or explain the same first answer or the modified first answer in view of the different first answer and the different second answer that disagree with the first answer and the second answer.

18. The method of claim 17, further comprising:
finding, in the at least one non-transitory computer-readable medium, another second answer of another online learner and associated with another first answer of the other online learner, wherein the other first answer and the other second answer agree with the first answer and the second answer of the online learner;
presenting the other second answer that agrees with the second answer through the client device to the online learner; and
asking the online learner through the client device to read and provide an evaluation of the other second answer.

19. The method of claim 17, further comprising:
receiving at least one evaluation by at least one other online learner of the second answer of the online learner from at least one other client device associated with the at least one other online learner;
storing the at least one evaluation in association with the second answer in the at least one non-transitory computer-readable medium;
receiving, from a client device associated with a course instructor, an evaluation by the course instructor of the second answer of the online learner; and
presenting to the online learner through the client device associated with the online learner feedback on an exercise comprising the first and second questions, wherein the feedback includes the at least one evaluation by the at least one other online learner and the evaluation by the course instructor.

20. The method of claim 17, further comprising:
presenting to a course instructor through a client device associated with the course instructor an interface to evaluate the online learner's second answer;
receiving an evaluation by the course instructor of the online learner's second answer from the client device associated with the course instructor; and
presenting to the course instructor through the client device associated with the course instructor a grid with rows, wherein one of the rows includes a name of the online learner, the first answer, the second answer, an evaluation by the online learner of the different second answer of the different online learner, an evaluation of the second answer of the online learner by at least one other online learner; and the evaluation by the course instructor of the second answer of the online learner.
